(19) United States
(12) Patent Application Publication
(10) Pub. No.: US 2006/0238028 A1
(43) Pub. Date: Oct. 26, 2006

(54) Power supply unit with a safety device and a massage machine provided with the power supply unit

(76) Inventor: Katsuyoshi Gotou, Osaka-shi (JP)

Correspondence Address: FLYNN THIEL BOUTELL & TANIS, P.C., 2026 RAMBLING ROAD, KALAMAZOO, MI, 49008-1631, US

(21) Appl. No.: 11/410,377

(22) Filed: Apr. 25, 2006

(30) Foreign Application Priority Data
Apr. 25, 2005 (JP) 126436 OF 2005

(51) Int. Cl. H02G 3/00

(52) U.S. Cl. 307/10.1

(57) ABSTRACT

It offers that a power supply unit with a safety device and a massage machine provided with the power supply unit that maintains off-state in the power ON/OFF switch of the main body of the message machine so as not to be unlocked easily and also prevents children and infants from operating it easily.

A power switch supply button 22a and a safety device 3a that locks ON/OFF switch in off-state are equipped in the main body of the massage chair power supply unit 2a of the massage machine main body 1a. When a power supply switch button 22a is in off-state, the energization of a power supply cord 24a and the power supply switch button 22a are disabled, so that even if the power supply switch button 22a is switched on, the power supply to massage machine main body 1a is locked in off-state. The said safety device 3a means that a keylock that has key insertion part, a card reader unit, a ten-key unit and a fingerprint recognition.

### BACKGROUND OF THE INVENTION

The present invention relates to a power supply unit with a safety device in addition to a limitation to ON/OFF switch of a power supply to enhance safety, and a massage machine providing the power supply unit which is supplied with this power supply unit.

Free medical treatment operation such as massaging and tapping is enforceable in strength corresponding to the demand of those who receive the treatment gratuitously in general massage machines. Reclining functions have been installed in the backrest of most chair type massage machines.

Also since the majority of massage machines including chair type massage machines circulated in markets now are designed for the assumption of adult use, they are not sustainable in the design for child and infant use under the current status.

Since the use of these general type of massage machines for infants and children on their own is not assumed, it induced accidents by improper use beyond guardians' surveillance or lack of supervision, and there was danger to have injury occurred in the past.

Under the above circumstances, there was a type of massage machines employing power supply unit with a knob or a coin type knob or a button, and was equipped with a safety device that locked ON/OFF switch in off-state of the main body of the massage chair to prevent improper use of the massage machine by infants and children.

For instance, so as to prevent children from easily touching the power supply switch, a power supply unit 41 is installed on the edge of the back side part 2 of a chair type massage machine 3 (Refer to FIG. 9). The power supply unit 41 has a power supply switch 11 and a lock button 44 to lock the power ON/OFF switch in off-state for the power supply switch 11 with input part 43 of operation dexterity cord installation part 45 and a power supply cord 42.

Then when using this chair type massage machine 3, firstly the lock is released by operating the lock button 44 of the said power supply switch. After the power supply switch 11 is made to be on-state, the chair type massage machine 3 is made to work by operating a switch installed in an operation machine (Figure is not shown). Moreover, after using the chair type massage machine, with turning off the power supply switch 11, off-state of the power supply switch 11 is made to be locked by operating the lock button 44 for the power ON/OFF switch.

Patent Document 1: Kokai (Jpn.unexamined patent publication) No.09-140757 page 11 and FIG. 18

### SUMMARY OF THE INVENTION

However, there was a possibility for children to unlock off-state of the power ON/OFF switch by operating the said switch, the button and so on in the massage machine that had the power supply unit with the type of the said composition, and the massage machine with the power supply unit. Therefore, danger for which infants and children use of the chair type massage machine and other on their own could not be solved and remained. Especially, there was a problem that in case the said power supply unit was installed in the part of the massage machine which was easily seen, it increased the risk of improper use by children and others.

Whereat the present invention was made to solve the existing said various problems. The main issue is that maintaining off-state in the power ON/OFF switch of the main body of the message machine so as not to be unlocked easily, and also offering the massage machine that has the power supply unit and the power supply unit providing with the safety device to prevent children and infants from operating it easily.

That is, the feature of the power supply unit that provides with the safety device of this invention is as follows. In a case-shaped power supply box accommodating a power supply switch button with an ON/OFF switching function and a fuse for preventing an overcurrent from flowing, a power supply unit with a safety device, said safety device comprising a lock mechanism for controlling power supply to the main body of a massage machine by using a specific medium or preset information and said safety device being accommodated in said power supply box.

The feature of the power supply unit with a safety device of this present invention comprises a device main body having a key insertion part and a keylock device including a key insertable into said key insertion part.

Characteristically the power supply unit that provides with the safety device of the present invention is to adopt the following keylock. First, an appropriate key is inserted in the key insertion part of the main body of the device. Next, the power supply to the main body of the massage machine becomes available by turning the key to a fixed angle. The power supply to the main body of the massage machine is disabled by extracting the key from the said key insertion part after turning the key for a fixed angle in opposite direction.

Moreover the feature is that the power supply unit with the safety device of the present invention is a card reader.

The feature of the power supply unit with the safety device of the present invention is that the safety device is composed by a ten-key unit. By inputting at least two or more preset personal identification numbers, setting or releasing the lock for the power supply to the main body of the massage machine is able to control.

The power supply unit that-provides with the safety device of the present invention features that the safety device is composed of a fingerprint authentication unit by identifying a human body by his finger print.

The feature of this machine is that the main body of the massage machine with the power supply unit of the present invention composed by a seat and a reclining backrest has the power supply unit that provides with the safety device on the bottom rear edge of the main body of the massage machine.

Since the power supply unit of the present invention adopts the safety device that installs the lock mechanism to control the power supply to the main body of the massage machine by using a specific medium or preset information built in a power supply box, so that it prevents children and infants from having a risk of accidents with operations of the machines on their own by not giving them said specific medium or information preset.

Furthermore the present invention composes of a power supply unit which has a key insertion part in the main body of the device and the keylock with a key insertable into said key insertion part of the main body of the device, so that it enables a simple and easy operation.

In the present invention, said keylock opens the power supply by rotating the key for a fixed angle in a certain direction after inserting the key in the key insertion part. The power supply is disabled by extracting the key from the keyhole insert after rotating the key for a fixed angle to the opposite direction. Therefore it enables a simple and easy operation to open and disable the power supply, and that possible to keep the key in the key insertion part and prevent from the loss when supplied the power.

The power supply unit that provides with the safety device of the present invention is composed of the card reader. Therefore, users are easily definable, and it enables to improve safety.

The present invention enables to control the setting of locking and unlocking for the power supply by inputting a at least two or more preset personal identification numbers in a ten-key unit, so that it allows to improve safety by limiting users easily with an easy operation.

Moreover, a user or a person who is allowed to use the massage machine is limited to a specific individual who has a finger print authenticated by the fingerprint authentication device by making the safety device of the present invention a fingerprint authentication device identified by a human body's finger print. By doing so it is beneficial for a further improvement of safety.

Furthermore, the massage machine equipped with the power supply unit of the present invention has the said type of the power supply unit on the bottom rear edge of the main body of the massage machine, so that infants and children cannot release off-state for the power ON/OFF switch on their own. Therefore, it becomes possible that the massage machine has a high security which prevents children and infants from a risk of improper use.

### BRIEF DESCRIPTION OF THE DRAWINGS

FIG. 1 is an oblique perspective figure showing one embodiment of the power supply unit that provides with the safety device of the present invention.

FIG. 2 is an oblique perspective figure showing one embodiment that the safety device for the power supply unit that provides with the safety device of the present invention makes a keylock.

FIG. 3 is an oblique perspective figure showing one embodiment that the safety device for the power supply unit with the safety device of the present invention makes a card reader device.

FIG. 4 is an oblique perspective figure showing one embodiment that the safety device for the power supply unit with the safety device of the present invention makes a ten-key unit.

FIG. 5 is an oblique perspective figure showing one embodiment that the safety device for the power supply unit with the safety device of the present invention makes a fingerprint authentication device.

FIG. 6 is a front explanation view showing one embodiment of the keylock for the power supply unit with the safety device of the present invention.

FIG. 7 is a circuit diagram showing one embodiment of the electric circuit for the power supply unit with the safety device of the present invention.

FIG. 8 is a rear perspective view showing one embodiment of the massage machine with the power supply unit of the present invention.

FIG. 9 is a reference drawing showing conventional technology.

### DETAILED DESCRIPTION

Explanation in detail of the power supply unit with the safety device of the present invention and the massage machine with the power supply unit in accordance with one embodiment shown in the drawings is as follows.

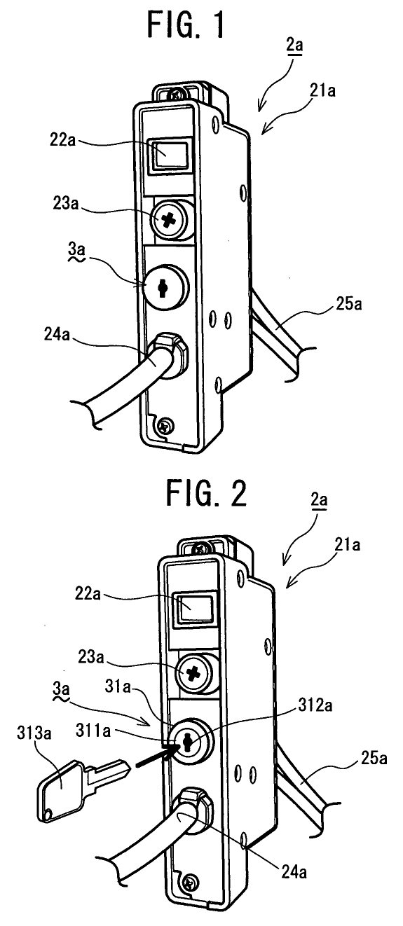

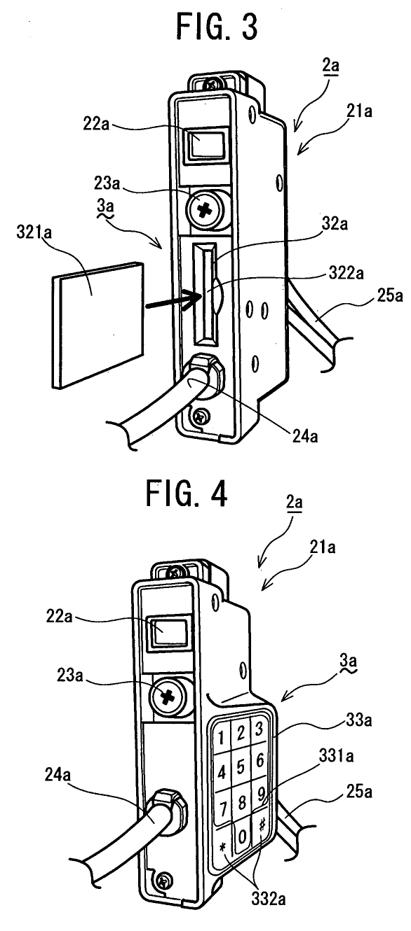

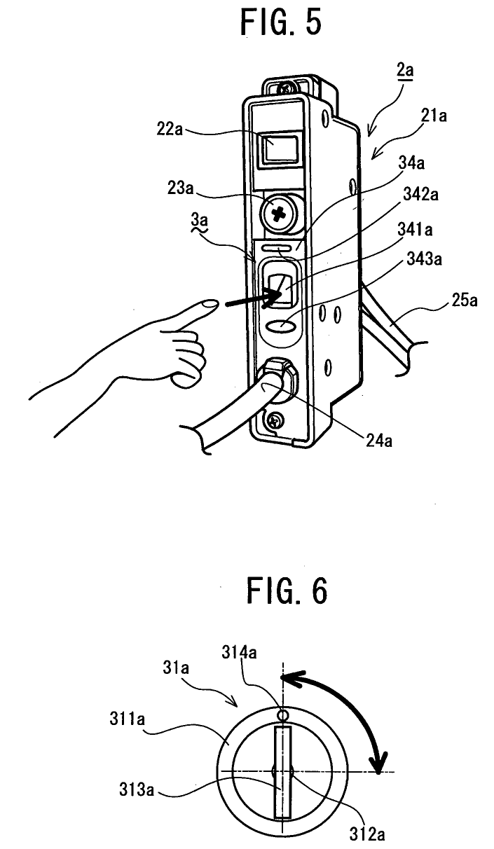

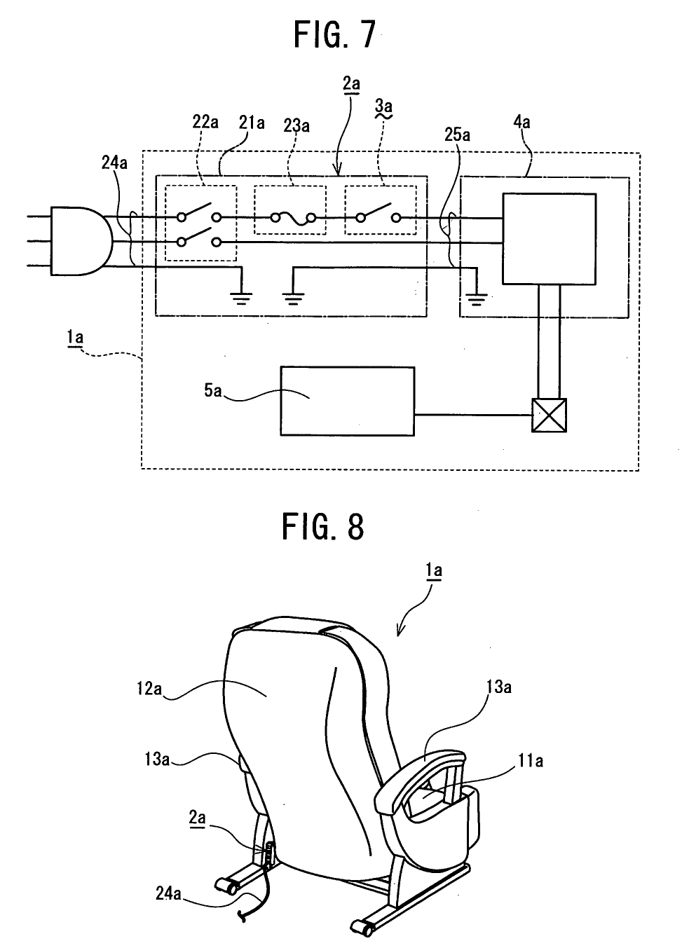

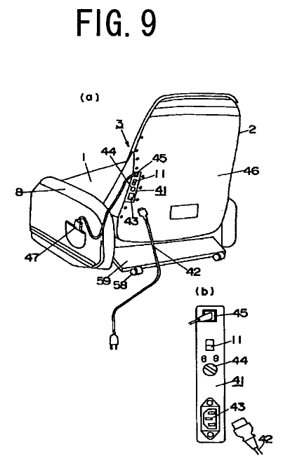

FIG. 1 is an oblique perspective figure showing one embodiment of the power supply unit with the safety device of the present invention. FIG. 2 is an oblique perspective figure showing one embodiment that the safety device for the power supply unit with the safety device of the present invention makes a keylock. FIG. 3 is an oblique perspective figure showing one embodiment that the safety device for the power supply unit with the safety device of the present invention makes a card reader. FIG. 4 is an oblique perspective figure showing one embodiment that the safety device for the power supply unit with the safety device of the present invention makes a ten-key unit. FIG. 5 is an oblique perspective figure showing one embodiment that the safety device for the power supply unit with the safety device of the present invention makes a fingerprint authentication device. FIG. 6 is a front explanation view showing one embodiment of the keylock for the power supply unit with the safety device of the present invention. FIG. 7 is a circuit diagram showing one embodiment of the electric circuit for the power supply unit with the safety device of the present invention. FIG. 8 is a rear perspective view showing one embodiment of the massage machine with the power supply unit of the present invention. FIG. 9 is a reference drawing showing conventional technology.

That is, it provides with a power supply unit with the safety device 2a of the present invention at the rear proper place of main body of the massage machine main body that is the chair type massage machine as one embodiment as shown in FIG. 8. The every following equipment is built into a case-shaped power supply box 21a as shown in FIG. 1. On the top of that there is a seesaw-shaped power supply switch button 22a that has a switch with ON/OFF function. Fuse 23a that prevents an overcurrent from flowing is disposed under the setup power supply switch button 22a. Safety device 3a, which is described afterward, is a lock mechanism under the fuse 23a to control power supply to main body of the said massage machine.

Rear anchor of power supply cord 24a to connect it with an external power supply is connected in front of the said power supply box 21a and downward of said safety device 3a as shown in FIG. 1 and FIG. 7. Electricity is supplied in from here to power supply box 21a. In addition, wiring cord 25a has come out from the back of the power supply box 21a. And, the wiring cord 25a energizes the connection to transformer 4a and control circuit board 5a of the massage machine main body 1a.

Safety device 3a that is the said lock mechanism controls the power supply to the said massage machine main body 1a. That is, when said power supply switch button 22a is in off-state, it puts it into the state to come to a rupture energizing of said wiring cord 25a and said power supply switch button 22a with the safety device 3a as shown in FIG. 7. Then, even if power supply switch button 22a is switched on, the power supply to massage machine main body 1a is locked in off-state.

The lock of safety device 3a is first released to put the power supply to the massage machine main body 1a in on-state, and it puts it into the state that can be energized. Next, power supply switch button 22a is turned on.

The safety device 3a that is the said lock mechanism controls the power supply to massage machine massage machine 1a by using a specific medium or preset information.

FIG. 2 shows that one composing of key 313a that is a specific medium that said safety device 3a can be inserted in device main body 311a, which is a cylinder-shaped from a front view, and the key insertion part 312a that has keyhole insertion part 312a.

When inserting said key 313a into the said key insertion part 312a as shown in FIG. 2, energizing of said wiring cord 25a and said power supply switch button 22a becomes possible. Oppositely when extracting the key 313a from key insertion part 312a, energizing of said wiring cord 25a and said power supply switch button 22a is disabled.

Therefore, off-state of the power supply to the massage machine main body 1a can be maintained unless said key 313a is inserted in the said key insertion part 312a.

Although the said device main body 311a is installed between said fuse 23a and said power supply cord 24a, the position of the said device main body 311a may not be limited to this position, and may be changed to a proper position.

In addition, the following are shown in FIG. 6. Said keylock 31a opens the power supply to the said massage machine main body 1a by rotating the key 313a to a fixed angle to a fixed direction after inserting the key 313a in the key insertion part 312a of the device main body 311a. The power supply to the massage machine main body 1a is disabled, and maintained off-state by extracting the key 313a from the key insertion part 312a after rotating the key 313a to a fixed angle to the opposite direction.

Although the said fixed angle of rotating the key 313a is set until the key 313a is rotated a full 90 degrees clockwise as shown in the Figure, this angle may not limit to 90 degrees, and can be accordingly set to below or above of this angle.

Round mark 314a that shows the position of said key 313a in which it is able to extract and insert in the part right above of said keyhole insertion part 312a. It is possible that the key 313a can be moved when the key 313a look towards the direction of the round sign 314a. Otherwise it is impossible to insert and extract the key 313a.

The composition is that when said key 313a is inserted toward the direction of the said round mark 314a with a clockwise turn and only said key 313a is turned up to the 90 degrees position, said wiring cord 25a and said power supply switch button 22a is energized. Then the power supply to the massage machine main body 1a is released.

Also, the power supply unit with safety device 2a of the present invention controls the power supply by using preset information as a safety device 3a that is a lock mechanism.

That is, information can be input and output as shown in FIG. 3. A card reader unit 32a recognizes the information memorized in a card 321a that has a memory unit (Figure is not shown) that memorizes the information can be introduced as the said safety device 3a.

In said card reader unit 32 a, card insertion part 322a where said card 321a is inserted has been installed in the front proper place of the said power supply box 21a.

Moreover, in the said card reader unit 32a has installed a control part (Figure is not shown) to collate and to process information recognized by reading it from the card 321a and internally setup information.

For instance the said memory unit can be composed of that is not applied only to magnetism, optical record memory and IC memory, etc as long as it is able to input, output and memorize information.

Even if said power supply switch button 22a is switched on, as long as said card 321a is not inserted in said card insertion part 322a of said card reader unit 32a, the power supply to said massage machine main body 1a is disabled. Off-state of the power supply can be maintained.

The procedure for releasing off-state of the power supply to the said massage machine main body 1a is as follows. When the said card 321a is inserted in card insertion part 322a of said card reader unit 32a, the card reader unit 32a recognizes information memorized on the card 321a. At the same time the said control part collates whether the information matches to the said setup information that is setup in the card reader unit 32a. If those information are matched, the said wiring cord 25a and the said power supply switch button 22a can be energized, and off-state of the power supply to massage machine main body 1a is released.

Although the said card reader unit 32a has been installed between the said fuse 23a and the said power supply cord 24a, the position may not be limited to this position, and be changed to a proper position.

Moreover, as a composition which safety device 3a as a lock mechanism controls the power supply by using preset information, shown in FIG. 4, it provides with a ten-key unit 33a that can input at least two or more preset personal identification numbers.

Said ten key-unit 33a is composed of number input part 331a where figure from 0 to 9 is marked down on surface, function input part 332a which is to select specific function of marked down sign of “*” and “#” on surface, and control part (Figure is not shown) that processes computation and memory of information input from number input part 331a and function input part 332a.

First, possible password is input in the number input part 331a after “*” in the said function input part 332a is input to set number of at least two or more as personal identification numbers in the said number input part 331a. For example, after “2” is input “5” can be input next. Afterwards by inputting “#” in the function input part 332a in the figure input part 331a, “25” is set as personal identification numbers the said control part.

After the personal identification numbers are set as mentioned above, the said wiring cord 25a and the said power supply switch button 22a cannot be energized even if the said power supply switch button 22a is switched on as long as the personal identification numbers are not input in the said number input part 331a, the power supply to massage machine main body 1a is not performed, and off-state of the power supply can be maintained.

In order to release off-state of the power supply to the said massage machine main body 1a, “*” and “#” in the said function input part 332a is pressed at the same time, when the password number is set to “25” as previously stated, and “25” is input in the said number input part 331a next. In this case, energizing of the said wiring cord 25a and the said power supply switch button 22a becomes possible because it matches to the personal identification numbers that are memorized and set in the said control part. Then the power supply to the massage machine main body 1a can be provided the power.

It is possible to install a specific personal identification numbers beforehand or installing a specific procedure using the said number input part 331a and the said function input part 332a, in case that a user forget the personal identification numbers set by the user.

Said ten-key unit 33a is installed on a right side of the power supply box 21a in FIG. 4. However, it does not limit to this position, and the position can be changed to a proper position. Moreover, each number on the number unit part 331a and “*” and on the function input part 332a can be arrayed in a row.

In addition, fingerprint recognition 34a identifying human body's finger print as shown in FIG. 5 can be adopted as a composition in which the power supply is made to be controlled by using preset information as a safety device 3a that is a lock mechanism.

Functions of the said fingerprint recognition 34a includes figure contact surface 341a to recognize the information of finger print by touched a finger, recognition register button 342a to recognize and register finger print information in figure contact surface 341a, checking authentication button 343a to match finger print information that finger print information contacts on the figure contact surface 341a and finger print information that has already been registered.

Moreover, the control part has been installed in the said fingerprint recognition 34a which the figure is not shown. The control part memorizes finger print information, and it controls each function of the said figure contact surface 341a, said recognition register button 342a and said checking authentication button 343a. Furthermore when checking authentication button 343a boots up, finger print information that has already been registered with recognition register button 342a and finger print information contacts on the figure touch screen 341a are distinguished whether to match.

In order to register finger print information in the said fingerprint recognition 34a, firstly the said recognition register button 342a is pressed, and by touching the said figure contact surface 341a, the finger print information is memorized in the said control part and completes registration. Also for instance, it may be notified according to display lights and sounds, etc. if the finger print information is correctly registered though the figure is not shown.

After finger print information is registered with the said fingerprint recognition 34a as mentioned above, the said wiring cord 25a and the said power supply switch button 22a cannot be energized even if the said power supply switch button 22a is switched on, unless the registered finger print information is input. Then the power supply to massage machine main body 1a is not performed, and off-state of the power supply can be maintained.

In order to release off-state of the power supply to the said massage machine main body 1a, after the said checking authentication button 343a is pressed, a finger is touched to the said finger contact surface. Then the said control part distinguishes whether the finger print information that has already been registered with recognition register button 342a and the finger print information contacted on the figure contact surface 341a are matched. If they are matched, the said wiring cord 25a and the said power supply switch button 22a are energized, and the power supply to the massage machine main body 1a can be provided the power.

Although the said fingerprint recognition 34 has been installed between the said fuse 23a and the said power supply cord 24a, the position may not be limited to this position, and may be changed to a proper position.

When the said safety device 3a is properly composed of each one of the said keylock 31a, the said card reader unit 32a, the said ten-key unit 33a, and the said fingerprint recognition 34a, children and infants are not able to operate the power supply unit easily, and safety is enhanced.

In addition, the present invention is, as one embodiment as shown in FIG. 8, a chair type massage machine with a power supply unit with safety device 2a that has the safety device of the said constituent attached to the massage machine main body 1a.

The said massage machine main body 1a is composed of the Seat 11a that human's buttocks touch, backrest 12a that dorsal of human body touches and is available in reclining behind seat 11a, and armrest 13a that arms or etc of human body touch to both right and left sides of seat 11a.

The said backrest 12a has free medical treatment operation providing massaging movement for instance as massaging movement, massaging, tapping, rolling, vibrating and etc is set up inside.

The massage machine providing the power supply unit with safety device 2a of the present invention has the power supply unit with safety device 2a of the present invention of the type of the said composition on the bottom rear edge of the massage machine main body. That is, it is equipped in the rear side and inside of the armchair 13a that is the vicinity of the left side of the bottom edge of part of the said backrest 12a. Then by making composition as stated, so as not to unlock off-state of the power supply to the massage machine main body 1a by children and infants on their own, power supply unit with safety device 2a can be placed in the part which is hidden from their eyes.

1. In a case-shaped power supply box accommodating a power supply switch button with an ON/OFF switching function and a fuse for preventing an overcurrent from flowing, a power supply unit with a safety device, said safety device comprising a lock mechanism for controlling power supply to the main body of a massage machine by using a specific medium or preset information and said safety device being accommodated in said power supply box.

2. The power supply unit with a safety device according to claim 1, wherein said safety device comprises a device main body having a key insertion part and a keylock device including a key insertable into said key insertion part.

3. The power supply unit with a safety device according to claim 2, wherein said keylock device is capable of supplying power to the main body of said massage machine when said key is inserted into said key insertion part of the main body of said device and turned for a fixed angle and power supply to the main body of said massage machine is disabled when said key is turned for a fixed angle to the opposite side and extracted from said key insertion part.

4. The power supply unit with a safety device according to claim 1, wherein said safety device is a card reader.

5. The power supply unit with a safety device according to claim 1, wherein said safety device is a ten-key unit for setting or releasing the lock to control power supply to main body of the massage machine by inputting not at least two or more preset personal identification numbers.

6. The power supply unit with a safety device according to claim 1, wherein said safety device is a finger print authentication unit by identifying a human body by his finger print.

7. In the main body of a massage machine including a seat and a backrest with a reclining function, a massage machine with a power supply unit characterized by providing the power supply unit according to claim 1 at the bottom end portion on the rear side of the main body of said massage machine.
